(19) United States
(12) Patent Application Publication
(10) Pub. No.: US 2023/0259258 A1
(43) Pub. Date: Aug. 17, 2023

(54) PRESENTATION AND CONTROL OF USER INTERACTION WITH A USER INTERFACE ELEMENT

(71) Applicant: Capital One Services, LLC, McLean, VA (US)

(72) Inventors: Erik Jay Salazar DE LEON, Richmond, VA (US); Xiang LAN, South Orange, NJ (US); Vivian WANG, McLean, VA (US)

(21) Appl. No.: 17/651,126

(22) Filed: Feb. 15, 2022

(51) Int. Cl. G06F 3/04842

(52) U.S. Cl. CPC G06F 3/04842

(57) ABSTRACT

In some implementations, a system may identify first and second user identifiers associated with first and second users, respectively. The system may determine first and second totals corresponding to the first and second user identifiers. The system may determine a ratio of the first total to the second total or a proportion of the first or second total relative to a joint total that is a sum of the first and second totals. The system may transmit user interface (UI) data associated with a UI element. The UI data indicates first and second user portions corresponding to the first and second users, and a connecting portion that connects the first and second user portions. Sizes of the first and second user portions are based on the ratio, of the first to second total, or the proportion of the first or second total relative to the joint total.

### BACKGROUND

A display of a user device may display a user interface (e.g., a graphical user interface). A user interface may permit interactions between a user of the user device and the user device. In some cases, the user may interact with the user interface to operate and/or control the user device to produce a desired result. For example, the user may interact with the user interface of the user device to cause the user device to perform an action. Additionally, the user interface may provide information to the user.

### SUMMARY

Some implementations described herein relate to a system for providing data for presentation of a user interface element. The system may include one or more memories and one or more processors communicatively coupled to the one or more memories. The one or more processors may be configured to identify a first user identifier, associated with a first user, and a second user identifier associated with a second user. The one or more processors may be configured to determine a first total corresponding to the first user identifier, and a second total corresponding to the second user identifier. The one or more processors may be configured to determine a ratio of the first total to the second total or a proportion of the first total or the second total relative to a joint total that is a sum of the first total and the second total. The one or more processors may be configured to transmit, to a user device, user interface data associated with the user interface element to be displayed on a display of the user device, wherein the user interface data indicates a first user portion, of the user interface element, corresponding to the first user, and a second user portion, of the user interface element, corresponding to the second user, wherein the user interface data indicates a connecting portion, of the user interface element, that connects the first user portion and the second user portion, and wherein a size of the first user portion and a size of the second user portion are based on the ratio, of the first total to the second total, or the proportion of the first total or the second total relative to the joint total.

Some implementations described herein relate to a method of providing data for presentation of a user interface element. The method may include receiving, by a system and from a user device, data indicating a request for information related to a user account, wherein the user account is associated with a first user and a second user. The method may include obtaining, by the system, a set of first user data indicating a set of first user values, of a plurality of first user values, over a time frame and associated with the first user. The method may include obtaining, by the system, a set of second user data indicating a set of second user values, of a plurality of second user values, over the time frame and associated with the second user. The method may include determining, by the system, a relationship between the set of first user values and the set of second user values. The method may include transmitting, by the system and to the user device, user interface data indicating the user interface element, where the user interface data indicates a first user portion of the user interface element, a second user portion of the user interface element, and a connecting portion, of the user interface element, that connects the first user portion and the second user portion, where the first user portion corresponds to the set of first user values, and the second user portion corresponds to the set of second user values, and where a size of the first user portion and a size of the second user portion are based on the relationship between the set of first user values and the set of second user values.

Some implementations described herein relate to a user device for presenting a user interface element. The user device may include one or more memories and one or more processors communicatively coupled to the one or more memories. The one or more processors may be configured to present, on a user interface associated with a user account, an interaction element. The one or more processors may be configured to detect a user interaction, with the user device, that indicates the interaction element. The one or more processors may be configured to present, on the user interface and based on the user interaction, the user interface element, wherein the user interface element includes a first user portion, a second user portion, and a connecting portion that connects the first user portion and the second user portion, wherein the first user portion corresponds to a first total associated with a first user account, and the second user portion corresponds to a second total associated with a second user account, and wherein a size of the first user portion and a size of the second user portion are based on a total ratio of the first total to the second total or a proportion of the first total or the second total relative to a joint total that is a sum of the first total and the second total.

### BRIEF DESCRIPTION OF THE DRAWINGS

FIGS. 1A-1D are diagrams of an example implementation relating to presentation and control of user interaction with a user interface element.

FIG. 2 is a diagram of an example environment in which systems and/or methods described herein may be implemented.

FIG. 3 is a diagram of example components of one or more devices of FIG. 2.

FIGS. 4-5 are flowcharts of example processes relating to presentation and control of user interaction with a user interface element.

### DETAILED DESCRIPTION

The following detailed description of example implementations refers to the accompanying drawings. The same reference numbers in different drawings may identify the same or similar elements.

Two or more users may share an account by which the users may participate in various activities (e.g., engaging in interactions with one or more third parties). The users may be joint account holders, or one user may be a primary account holder and user, while the other user(s) may be secondary users (e.g., dependents). Alternatively, each user may have separate individual accounts by which each user separately may participate in the various activities. The individual accounts may be linked to one another such that information and/or benefits (e.g., rewards points) related to the use of the accounts may be shared.

An institution operating the account(s) may maintain records of data corresponding to each activity. In some instances, one of the users may want to derive certain insights about the particular user's participation or the participation by the other user(s) in the various activities in a quick and efficient manner. For example, the user may want to compare relative contributions by one or more of the users to the shared benefits. Accordingly, a user interface (UI) that allows the user to view the data in an aggregated format may be beneficial. However, techniques frequently involve presenting the data on multiple UIs for each user. As a result, the user has to inefficiently determine any insights by navigating through UIs for different sets of data (e.g., for each user) presented on the UIs and manually combining and/or processing the data. Furthermore, requiring the user to navigate through different UIs inefficiently utilizes computing resources. Thus, it is desirable for a UI to provide a user-friendly and efficient way for a user to visualize and gain insights from the data.

Some implementations described herein enable a system to provide data for presentation of a UI element on a user device that visually indicates a comparison of a first set of data (e.g., corresponding to a first user) with a second set of data (e.g., corresponding to a second user), for example, the relative contribution of each user (e.g., a first user total and a second user total) to a joint total. The UI element may include multiple portions (e.g., a first user portion and a second user portion) corresponding to the users. The respective sizes of the multiple portions may be based on a relationship between the user contributions to the joint total. In some implementations, the relationship may be a ratio of one user's contribution (e.g., the first user total) to another user's contribution (e.g., the second user total). Alternatively, the relationship may be a proportion of one user's contribution (e.g., the first user total or the second user total) relative to the joint total. Accordingly, by using the UI element to aggregate data and visually depict one or more comparisons of data sets, rather than providing and presenting the data in multiple UIs and/or UI elements, computing resources can be conserved. For example, by the respective sizes of the first user portion and the second user portion, the processing system is able to illustrate to the user the relative contribution by each user to the joint total. Additionally, the UI element efficiently utilizes the display real estate of the user device without the need of multiple UIs to convey the requested information, thereby conserving computing resources.

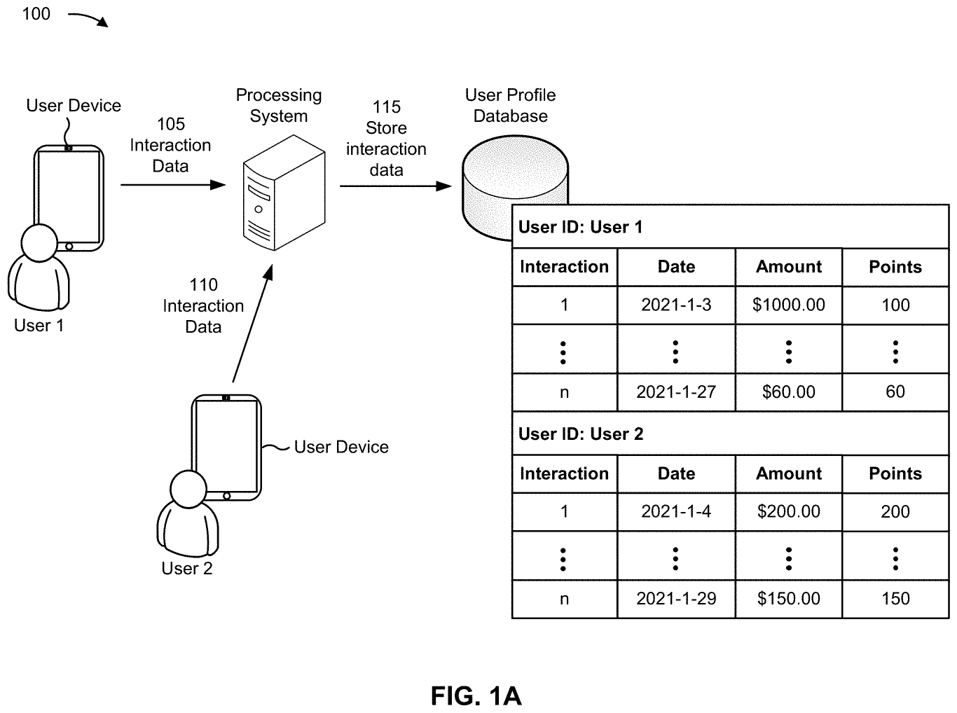

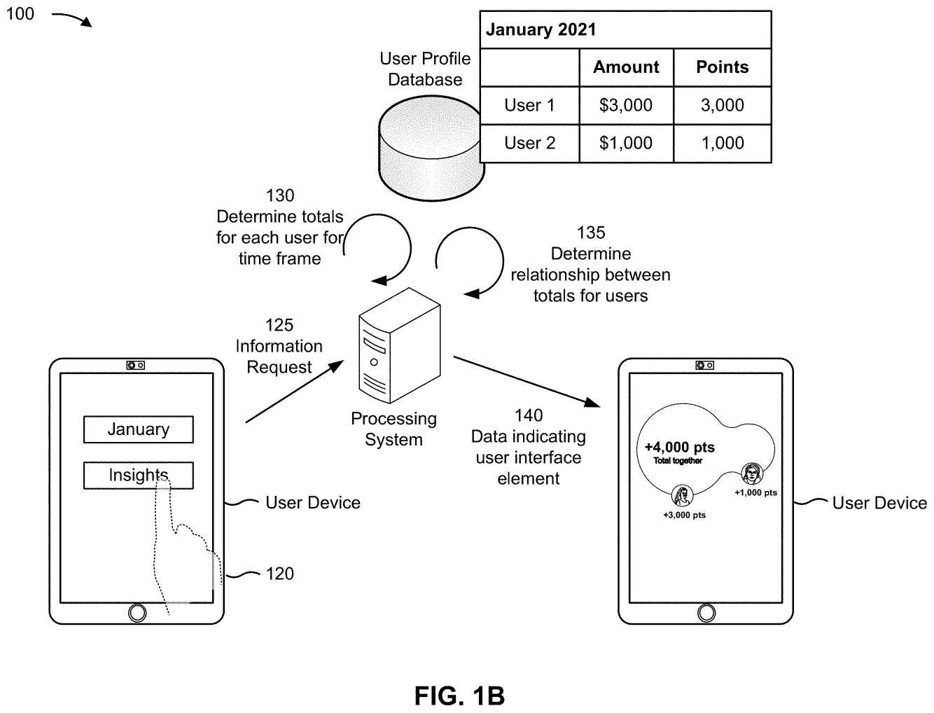

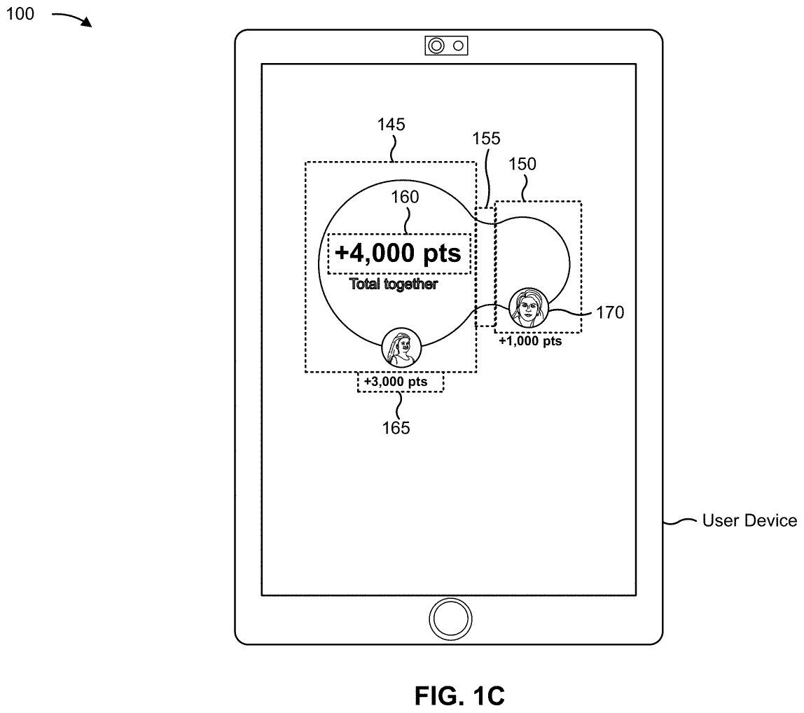

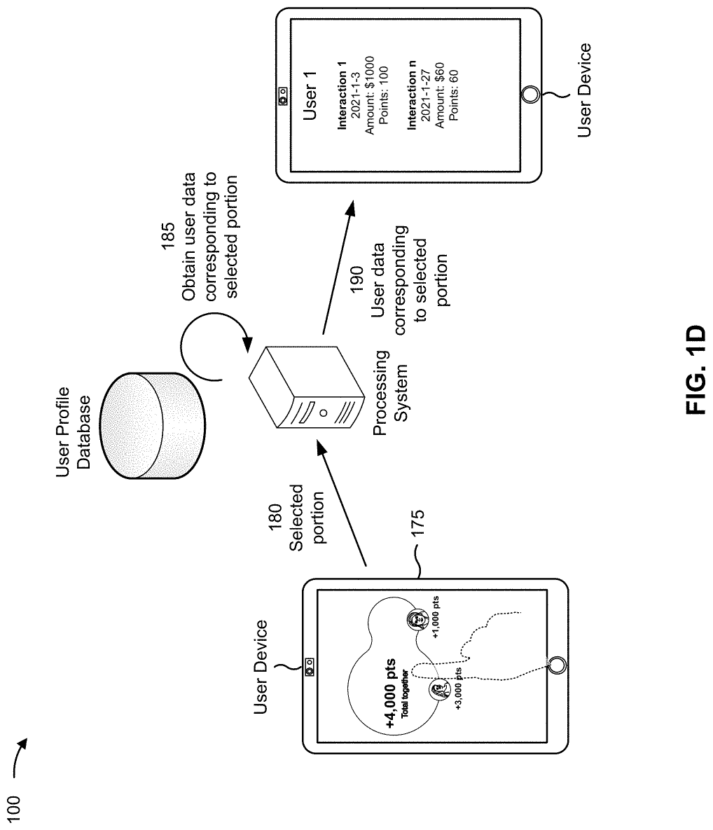

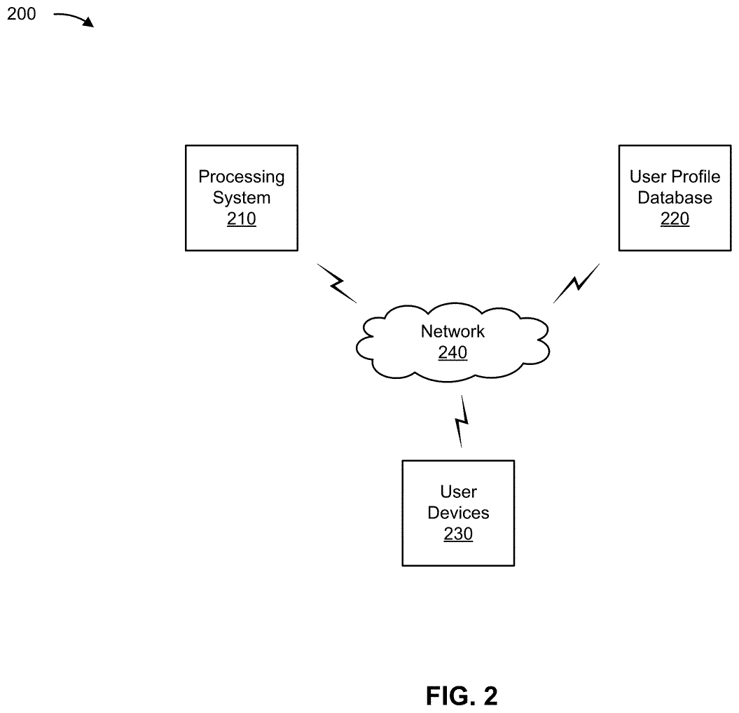

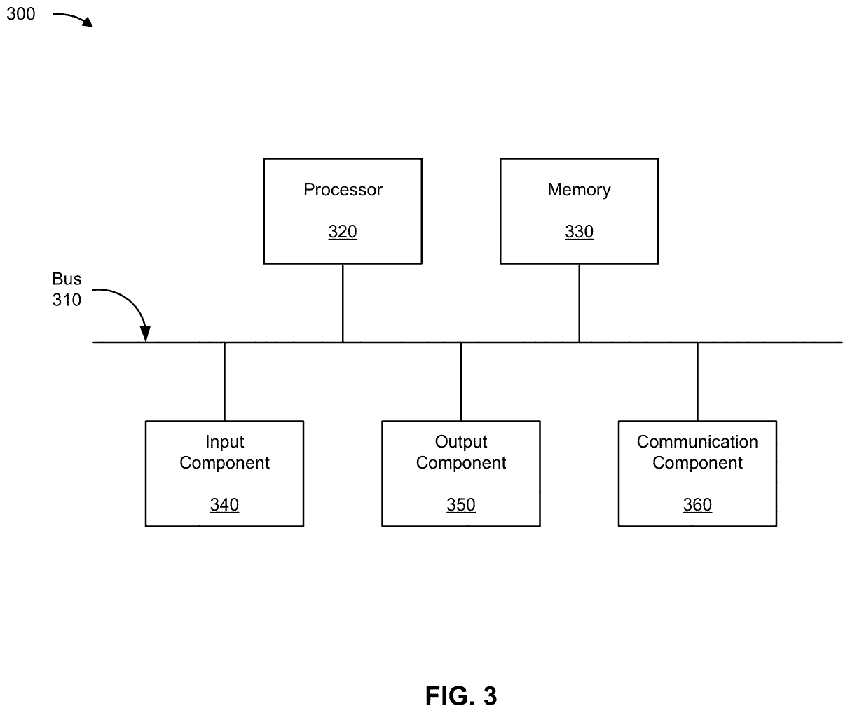

FIGS. 1A-1D are diagrams of an example 100 associated with presentation and control of user interaction with a UI element. As shown in FIGS. 1A-1D, example 100 includes a processing system, a user profile database, and user devices. These devices are described in more detail in connection with FIGS. 2 and 3.

As shown in FIG. 1A, a first user (e.g., User 1 in FIG. 1A) may engage in an interaction (e.g., a first user interaction) with a third party (e.g., a merchant or a service provider). For example, the first user may perform the first user interaction from a user device of the first user (e.g., a first user device), such as in an online transaction. As shown by reference number 105, the processing system may receive interaction data associated with the first user interaction from the first user device, such as over a network as described in more detail hereinafter. As further shown in FIG. 1A, a second user (e.g., User 2 in FIG. 1A) may engage in an interaction (e.g., a second user interaction) with another third party, which may be the same as or different from the third party in the first user interaction. For example, the second user may perform the second user interaction from a user device of the second user (e.g., a second user device). As shown by reference number 110, the processing system may receive interaction data associated with the second user interaction from the second user device, such as over the network. As another example, the first user and/or the second user may perform the respective interactions at a terminal (e.g., a point-of-sale (PoS) terminal at a location of the third party). In such a scenario, the processing system may receive the interaction data from the terminal.

The interaction data associated with the first user interaction and with the second user interaction may indicate respective times of the interactions and respective interaction amounts. Additionally, the interaction data may be accompanied by a first user identifier (e.g., a first user identifier or a second user identifier), by which the processing system may identify the user involved in the particular interaction, and/or an account identifier (e.g., an account ID number, a primary account number (PAN), or a virtual card number).

As shown by reference number 115, the processing system may store the interaction data (e.g., in a user profile database) for each interaction under one or more user accounts associated with the first user identifier and/or the second user identifier. For example, the first user and the second user may share a single user account (e.g., the first user and the second user are joint account holders, or the first user is a primary account holder and user, and the second user is a secondary user). In such a scenario, the first user identifier and the second user identifier may be associated with the single user account of the first user and the second user. The processing system may store interaction data associated with the first user interaction as first user interaction data under the first user identifier in the single user account, based on the first user identifier received with the interaction data from the first user interaction. Similarly, the processing system may store interaction data associated with the second user interaction as second user interaction data under the second use identifier in the single user account, based on the second user identifier received with the interaction data from the second user interaction.

Alternatively, the first user and the second user may each have a separate account (e.g., a first user account associated with the first user and having a first account identifier, and a second user account associated with the second user and having a second account identifier). In such a scenario, the first user identifier may be associated with the first user account of the first user, and the second user identifier may be associated with the second user account of the second user. The processing system may store the interaction data associated with the first user interaction as first user interaction data under the first user account based on the first user identifier and/or the first account identifier, and the interaction data associated with the second user interaction may be stored as second user interaction data under the second user account based on the second user identifier and/or the second account identifier.

Additionally, or alternatively, the first user and/or the second user may have one or more accounts of different account types (e.g., a checking account type, a savings account type, a credit account type, or a rewards account type). Each account identifier corresponding to a particular account may be associated with the account type in the user profile database.

In either scenario, the first user interaction data may include first user historical interaction data for a plurality of first user interactions associated with the first user. The first user historical interaction data may indicate a plurality of first user interaction amounts corresponding to the plurality of first user interactions. Similarly, the second user interaction data may include second user historical interaction data for a plurality of second user interactions associated with the second user. The second user historical interaction data may indicate a plurality of second user interaction amounts corresponding to the plurality of second user interactions.

As further shown by FIG. 1A, the first user interaction data and the second user interaction data may include a plurality of point values corresponding to the plurality of interactions (e.g., first user interactions and second user interactions). The processing system may determine the point values based on one or more rules related to the interaction data, such as the interaction amounts. For example, the point values for a particular interaction may be based on a percentage (e.g., 1%, 10%, 100%) of the interaction amount for that interaction. The percentage may vary depending on the value of the interaction amount. For example, if the interaction amount is within a first range (e.g., less than $1000), then the percentage may be a first percentage (e.g., 10%). If the interaction amount is within a second range (e.g., between $1000 and $10,000), then the percentage may be a second percentage (e.g., 100%). Alternatively, different interaction amounts or ranges of interaction amounts may be associated with set point values. For example, if the interaction amount is within a first range (e.g., less than $1000), then the point values may have a first value (e.g., 10 points). If the interaction amount is within a second range (e.g., between $1000 and $10,000), then the point values may have a second value (e.g., 100 points). The point values may be shared by the first user and the second user. For example, as discussed in more detail hereinafter, the point values associated with the first user interactions (e.g., first user point values) may be combined with the point values associated with the second user interactions (e.g., second user point values) to be used by either user. As a result, the first user may use the second user point values, and the second user may use the first user point values.

As shown in FIG. 1B, one of the users (e.g., the first user or the second user) may initiate a request for information (e.g., insights) about the user's account (e.g., the single user account shared by the first user and the second user, or the dedicated user account of the particular user) from the user device, such as via an application stored on the user device or via a web-based application accessed by the user over the network. For example, as shown by reference number 120, the user may input the request via the user device by selecting a dedicated option (or interaction element) to access the information (e.g., via a button on a touchscreen display of the user device). Additionally, the user may specify a time frame (e.g., calendar month and/or year) for which the user would like the information. The user device may detect the user interaction with the interaction element. As shown by reference number 125, the processing system may receive (e.g., from the user device) data indicating the information request.

As shown by reference number 130, the processing system may determine user totals (e.g., a first total corresponding to the first user identifier, and a second total corresponding to the second user identifier) for a particular time frame. To determine the first total and the second total, the processing system may identify the first user identifier and the second user identifier. For example, the processing system may receive the user identifier of the user requesting the information together with the request. Alternatively, the processing system may already have the user identifier (e.g., when the user logged into the user account). From the received user identifier, the processing system may access the user account associated with the user requesting the information. In scenarios in which the first user and the second user share a single user account, the processing system may identify the user identifier of the other user from the single user account. In scenarios in which the first user and the second user have separate user accounts, the first user account and the second user account may be linked in the user profile database. As a result, when the user access the user account associated with the user requesting the information, the processing system may identify the user identifier of the other user based on this link.

In some implementations, the first total may be a sum of a subset of first user interaction amounts corresponding to a subset of first user interactions that occurred within the time frame, and the second total may be a sum of a subset of second user interaction amounts corresponding to a subset of second user interactions that occurred within the time frame. For the first total, the processing system may obtain, from the user profile database and based on the first user identifier, a subset of the first user interaction data (e.g., a set of first user values) indicating the subset of first user interaction amounts, and determine the sum of the subset of first user interaction amounts. Similarly, for the second total, the processing system may obtain, from the user profile database and based on the second user identifier, a subset of the second user interaction data (e.g., a set of second user values) indicating the subset of second user interaction amounts, and the processing system may determine the sum of the subset of the second user interaction amounts.

Additionally, or alternatively, the first total may be a sum of a subset of first user point values corresponding to the subset of first user interactions that occurred within the time frame, and the second total may be a sum of a subset of second user point values corresponding to the subset of second user interactions that occurred within the time frame. For the first total, the processing system may obtain, from the user profile database and based on the first user identifier, a subset of the first user interaction data (e.g., a set of first user data) indicating the subset of first user point values, and the processing system may determine the sum of the subset of first user point values. Similarly, for the second total, the processing system may obtain, from the user profile database and based on the second user identifier, a subset of the second user interaction data (e.g., a set of second user data) indicating the subset of second user point values, and the processing system may determine the sum of the subset of the second user point values.

As shown by reference number 135, the processing system may determine a relationship between the first total and the second total (e.g., the set of first user data and the set of second user data). In some implementations, the processing system may determine a total ratio of the first total to the second total. For example, if the first total is 3,000 point values and the second total is 1,000 point values, as shown in FIG. 1B, then the ratio of the first total to the second total is 3:1. Additionally, or alternatively, the processing system may determine a proportion or percentage of the first total and/or the second total relative to a joint total that is a sum of the first total and the second total. For example, for the first total of 3,000 point values and the second total of 1,000 point values, the joint total is 4,000 point values, the proportion of the first total is 0.75, and the proportion of the second total is 0.25. From this relationship between the first total (or set of first user values) and the second total (or set of second user values), the processing system may determine parameters of the UI element, as described in more detail hereinafter. As shown by reference number 140, the processing system may transmit, to the user device, UI data indicating a UI element.

As shown in FIG. 1C, the UI element, as indicated by the UI data, may include a first user portion 145 corresponding to the first user, a first user account (e.g., an account of and/or associated with the first user), or the set of first user values, and a second user portion 150 corresponding to the second user, a second user account (e.g., an account of and/or associated with the second user), or the set of second user values. The first user portion 145 may have a first area, and the second user portion 150 may have a second area. The first user portion 145 and the second user portion 150 each may have an arcuate (e.g., circular or oval) shape, though the first user portion 145 and/or the second user portion 150 may have any geometric or non-geometric shape.

A size of the first user portion 145 and a size of the second user portion 150 may be based on the relationship between the first total (or set of first user values) and the second total (or set of second user values). For example, in some implementations, an area ratio of the first area of the first user portion 145 to the second area of the second user portion 150 may be the same as or similar to the total ratio. As an example, for a total ratio of 3:1, the area ratio may be similarly 3:1, and the first area is three times the second area. Alternatively, a first area proportion of the first area relative to a total area may be the same as or similar to the proportion of the first total relative to the joint total, where the total area is a sum of the first area and the second area. For example, for a proportion of 0.75 of the first total relative to the joint total, the first area proportion similarly may be 0.75, and a second area proportion of the second area relative to the joint total may be 0.25. As another example, in implementations in which the first user portion 145 and the second user portion 150 have arcuate shapes with radii (e.g., a first radius for the first user portion 145 and a second radius for the second user portion 150), a radius ratio of the first radius to the second radius may be the same as or similar to the total ratio. For example, for a total ratio of 3:1, the radius ratio may be similarly 3:1.

The UI element also may include a connecting portion 155 that connects the first user portion 145 and the second user portion 150. The connecting portion 155 may be concave (e.g., have concave profiles) on two opposing sides, providing a visual of the first user portion 145 and the second user portion 150 blending in with each other. Additionally, the UI element may include the joint total 160 across the first user portion 145, the second user portion 150, and/or the connecting portion 155. The UI element may also include each user contribution 165 to the joint total (e.g., the first total and the second total). Alternatively, each user contribution 165 may be provided and/or displayed separate from the UI element. For example, as shown in FIG. 1C, the user contribution 165 may be displayed external to the UI element. The UI element may also include an identifier 170 by which the respective users may be identified. For example, the identifier may include a picture of each user, as shown in FIG. 1C. Additionally, or alternatively, the identifier may be an avatar, an icon, a name, a username, or the like.

By way of the UI element, the processing system provides the requested information (e.g., insights) to the user (the first user or the second user) about the joint total contributed by the users in a compact and efficient manner. For example, by the respective sizes of the first user portion and the second user portion, the processing system is able to illustrate to the user the relative contribution by each user to the joint total. Additionally, the UI element efficiently utilizes the display real estate of the user device without the need of multiple UIs to convey the requested information, thereby conserving computing resources.

As shown in FIG. 1D and by reference number 175, the first user portion and the second user portion each may be selectable. For example, the user device may detect an interaction (e.g., a second user interaction) with a section of the touchscreen display of the user device corresponding to the first user portion or the second user portion (e.g., the selected portion). As shown by reference number 180 and based on the second user interaction, the processing system may receive from the user device selection data indicating the selected portion. As shown by reference number 185, the processing system may obtain, from the user profile database, historical interaction data of the user corresponding to the selected portion for the time frame. For example, if the selected portion is the first user portion, then the processing system may obtain historical interaction data corresponding to the first user for the time frame. As shown by reference number 190, the processing system may transmit, to the user device, account information, including the historical interaction data (e.g., date of the interactions, interaction amounts, point values) corresponding to the selected portion to be displayed on the display of the user device.

Although implementations are described herein in connection with joint totals of two users, techniques described herein may be used for joint totals of any number of users. Additionally, although implementations described herein refer to the first user account and the second user account as being associated with the first user and the second user, respectively, techniques described herein may be used for scenarios in which the first user account and the second user account are both associated with a single user (e.g., the first user). Using the techniques described herein, a user device may present, on a UI, a UI element that provides user-friendly visualization that aggregates comparative information to enable a user to efficiently gain insights about the user's account (e.g., shared interaction data with one or more other users or shared interaction data across multiple accounts of the user).

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a processing system 210, a user profile database 220, user devices 230, and a network 290. Devices of environment 200 may interconnect via wired connections, wireless connections, or a combination of wired and wireless connections.

The processing system 210 includes one or more devices capable of receiving, generating, storing, processing, providing, and/or routing information associated with presentation and control of user interaction with a user interface element, as described elsewhere herein. The processing system 210 may include a communication device and/or a computing device. For example, the processing system 210 may include a server, such as an application server, a client server, a web server, a database server, a host server, a proxy server, a virtual server (e.g., executing on computing hardware), or a server in a cloud computing system. In some implementations, the processing system 210 includes computing hardware used in a cloud computing environment.

The user profile database 220 includes one or more devices capable of receiving, generating, storing, processing, and/or providing information associated with presentation and control of user interaction with a user interface element, as described elsewhere herein. The user profile database 220 may include a communication device and/or a computing device. For example, the user profile database 220 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the user profile database 220 may store information associated with an account of a user, such as interaction data associated with interactions between the user and a third party, as described elsewhere herein.

The user devices 230 each includes one or more devices capable of receiving, generating, storing, processing, and/or providing information associated with presentation and control of user interaction with a user interface element, as described elsewhere herein. Each user device 230 may include a communication device and/or a computing device. For example, each user device 230 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 240 includes one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the processing system 210, the user profile database 220, and/or the user devices 230. In some implementations, the processing system 210, the user profile database 220, and/or the user devices 230 include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

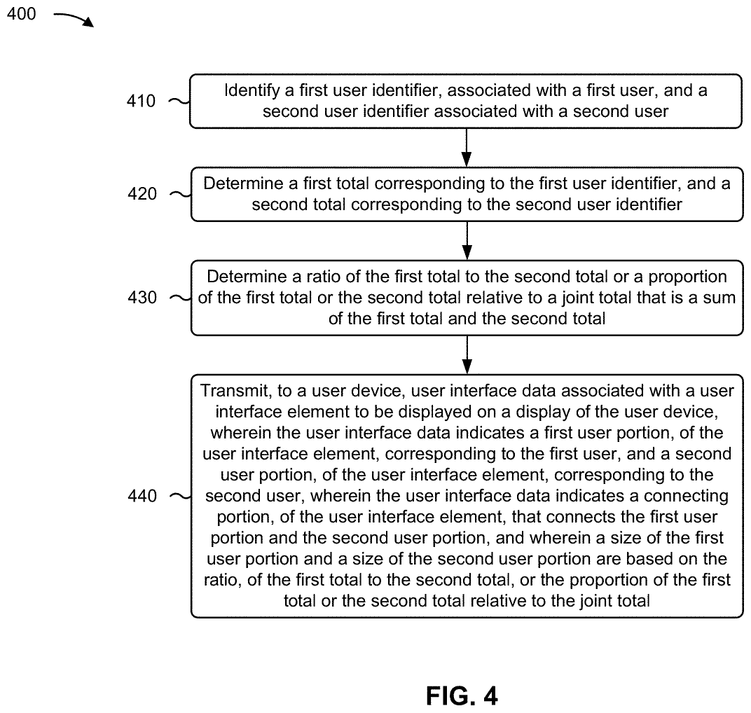

FIG. 4 is a flowchart of an example process 400 associated with presentation and control of user interaction with a user interface element. In some implementations, one or more process blocks of FIG. 4 may be performed by a system (e.g., processing system 210). In some implementations, one or more process blocks of FIG. 4 may be performed by another device or a group of devices separate from or including the system, such as user devices 230. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include identifying a first user identifier, associated with a first user, and a second user identifier associated with a second user (block 410). As further shown in FIG. 4, process 400 may include determining a first total corresponding to the first user identifier, and a second total corresponding to the second user identifier (block 420). As further shown in FIG. 4, process 400 may include determining a ratio of the first total to the second total or a proportion of the first total or the second total relative to a joint total that is a sum of the first total and the second total (block 430). As further shown in FIG. 4, process 400 may include transmitting, to a user device, UI data associated with a UI element to be displayed on a display of the user device (block 440). The UI data indicates a first user portion, of the UI element, corresponding to the first user, and a second user portion, of the UI element, corresponding to the second user. The UI data indicates a connecting portion, of the UI element, that connects the first user portion and the second user portion. A size of the first user portion and a size of the second user portion are based on the ratio, of the first total to the second total, or the proportion of the first total or the second total relative to the joint total.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 2-3.

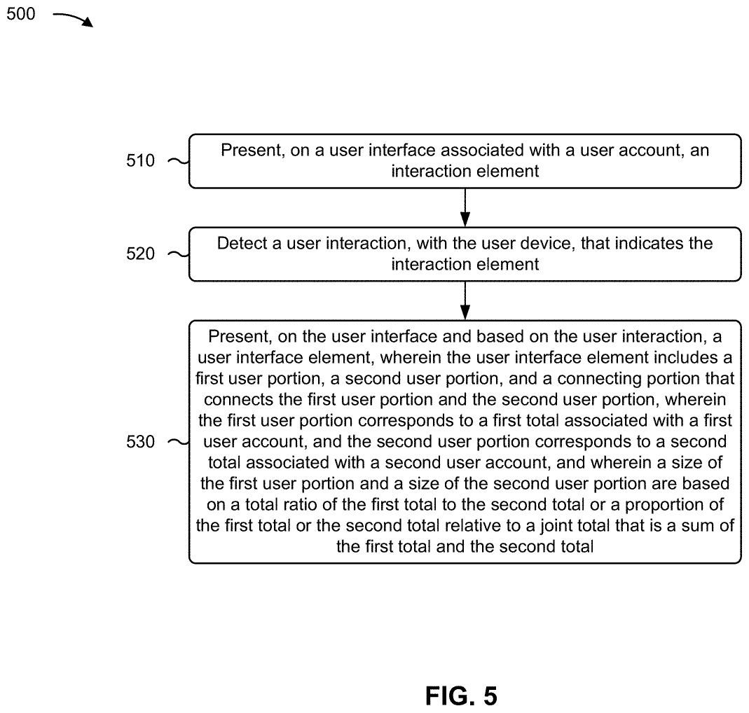

FIG. 5 is a flowchart of an example process 500 associated with presentation and control of user interaction with a user interface element. In some implementations, one or more process blocks of FIG. 5 may be performed by a user device (e.g., user device 230). In some implementations, one or more process blocks of FIG. 5 may be performed by another device or a group of devices separate from or including the user device, such as the processing system 210. Additionally, or alternatively, one or more process blocks of FIG. 5 may be performed by one or more components of device 300, such as processor 320, memory 330, input component 340, output component 350, and/or communication component 360.

As shown in FIG. 5, process 500 may include presenting, on a UI associated with a user account, an interaction element (block 510). As further shown in FIG. 5, process 500 may include detecting a user interaction, with the user device, that indicates the interaction element (block 520). As further shown in FIG. 5, process 500 may include presenting, on the user interface and based on the user interaction, the user interface element (block 530). The user interface element includes a first user portion, a second user portion, and a connecting portion that connects the first user portion and the second user portion. The first user portion corresponds to a first total associated with a first user account, and the second user portion corresponds to a second total associated with a second user account. A size of the first user portion and a size of the second user portion are based on a total ratio of the first total to the second total or a proportion of the first total or the second total relative to a joint total that is a sum of the first total and the second total.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 2-3.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for providing data for presentation of a user interface element, the system comprising:
one or more memories; and
one or more processors, communicatively coupled to the one or more memories, configured to:
identify a first user identifier associated with a first user based at least in part on an information request associated with the first user;
identify a second user identifier associated with a second user based at least in part on a linking relationship between the first user and the second user;
determine a first total corresponding to the first user identifier, and a second total corresponding to the second user identifier;
determine at least one of:
a ratio of the first total to the second total, or
a proportion of the first total or the second total relative to a joint total that is a sum of the first total and the second total; and
transmit, to a user device, user interface data associated with the user interface element to be displayed on a display of the user device,
wherein the user interface data indicates a shape that comprises:
a first user portion, of the shape, corresponding to the first user and having a first size that is based on the ratio or the proportion,
a second user portion, of the shape, corresponding to the second user and having a second size that is based on the ratio or the proportion, and
a connecting portion, of the shape, that connects the first user portion and the second user portion.

2. The system of claim 1, wherein the first user identifier is associated with a first user account of the first user, and the second user identifier is associated with a second user account of the second user.

3. The system of claim 1, wherein the first user identifier and the second user identifier are associated with a user account of the first user and the second user.

4. The system of claim 1, wherein the one or more processors are further configured to:
receive, from the user device, data indicating a selection of a selected one of the first user portion or the second user portion; and
transmit, to the user device, account information associated with one of the first user identifier or the second user identifier corresponding to the selected one of the first user portion or the second user portion.

5. The system of claim 1, wherein the one or more processors are further configured to:
receive interaction data associated with an interaction associated with the first user or the second user, wherein the interaction data indicates an interaction amount of the interaction; and
store the interaction data, in a user profile database and associated with the first user identifier or the second user identifier, as first user interaction data or second user interaction data,
wherein the first user interaction data includes historical interaction data for a plurality of first user interactions associated with the first user, wherein the historical interaction data indicates a plurality of first user interaction amounts corresponding to the plurality of first user interactions,
wherein the second user interaction data includes historical interaction data for a plurality of second user interactions associated with the second user, wherein the historical interaction data indicates a plurality of second user interaction amounts corresponding to the plurality of second user interactions, and
wherein the first total is based on the first user interaction data corresponding to a subset of the plurality of first user interactions that occurred in a time frame, and the second total is based on the second user interaction data corresponding to a subset of the plurality of second user interactions that occurred in the time frame.

6. The system of claim 5, wherein, to determine the first total and the second total, the one or more processors are configured to:
obtain, from the user profile database and based on the first user identifier, a subset of the first user interaction data indicating a subset of first user interaction amounts, of the plurality of first user interaction amounts, corresponding to the subset of the plurality of first user interactions that occurred in the time frame, wherein the first total is a sum of the subset of first user interaction amounts; and
obtain, from the user profile database and based on the second user identifier, a subset of the second user interaction data indicating a subset of second user interaction amounts, of the plurality of second user interaction amounts, corresponding to the subset of the plurality of second user interactions that occurred in the time frame, wherein the second total is a sum of the subset of second user interaction amounts.

7. The system of claim 5, wherein the first user interaction data includes a plurality of first user point values corresponding to the plurality of first user interactions, and the second user interaction data includes a plurality of second user point values corresponding to the plurality of second user interactions, and
wherein, to determine the first total and the second total, the one or more processors are configured to:
obtain, from the user profile database and based on the first user identifier, a subset of the first user interaction data indicating a subset of first user point values, of the plurality of first user point values, corresponding to the subset of the plurality of first user interactions that occurred in the time frame, wherein the first total is a sum of the subset of first user point values; and
obtain, from the user profile database and based on the second user identifier, a subset of the second user interaction data indicating a subset of second user point values, of the plurality of second user point values, corresponding to the subset of the plurality of second user interactions that occurred in the time frame, wherein the second total is a sum of the subset of second user point values.

8. A method of providing data for presentation of a user interface element, comprising:
receiving, by a system and from a user device, data indicating a request for information related to a user account, wherein the user account is associated with a first user;
identifying, by the system, a second user associated with the first user based at least in part on a linking relationship between the first user and the second user;
obtaining, by the system, a set of first user data indicating a set of first user values, of a plurality of first user values, over a time frame and associated with the first user;
obtaining, by the system, a set of second user data indicating a set of second user values, of a plurality of second user values, over the time frame and associated with the second user;
determining, by the system, a relationship between the set of first user values and the set of second user values; and
transmitting, by the system and to the user device, user interface data indicating the user interface element,
wherein the user interface data indicates a shape that comprises:
a first user portion, of the shape, that corresponds to the set of first user values and has a first size that is based on the relationship,
a second user portion, of the shape, that corresponds to the set of second user values and has a second size that is based on the relationship, and
a connecting portion, of the shape, that connects the first user portion and the second user portion.

9. The method of claim 8, wherein the user interface data indicates an arcuate shape for each of the first user portion and the second user portion.

10. The method of claim 9, wherein the relationship between the set of first user values and the set of second user values is a total ratio of a total of the set of first user values to a total of the set of second user values, and
wherein the shape indicates an area ratio, of a first area of the first user portion to a second area of the second user portion, wherein the area ratio is the same as the total ratio.

11. The method of claim 9, wherein the relationship between the set of first user values and the set of second user values is a total ratio of a total of the set of first user values to a total of the set of second user values, and
wherein the shape indicates a radius ratio, of a first radius of the first user portion to a second radius of the second user portion, wherein the radius ratio is the same as the total ratio.

12. The method of claim 8, wherein the shape indicates that the connecting portion is concave on opposing sides of the connecting portion.

13. A user device for presenting a user interface element, the user device comprising:
one or more memories; and
one or more processors, communicatively coupled to the one or more memories, configured to:
present, on a user interface associated with a user account, an interaction element;
detect a user interaction, with the user device, that indicates the interaction element, wherein the user interaction is associated with an information request associated with a first user account, the first user account being associated with a second user account based at least in part on a linking relationship between the first user account and the second user account; and
present, on the user interface and based on the user interaction, the user interface element,
wherein the user interface element indicates a shape that includes:
a first user portion, of the shape, that corresponds to a first total associated with the first user account,
a second user portion, of the shape, that corresponds to a second total associated with the second user account, and
a connecting portion, of the shape, that connects the first user portion and the second user portion,
and
wherein a size of the first user portion and a size of the second user portion are based on at least one of:
a total ratio of the first total to the second total, or
a proportion of the first total or the second total relative to a joint total that is a sum of the first total and the second total.

14. The user device of claim 13, wherein each of the first user portion and the second user portion has an arcuate shape.

15. The user device of claim 14, wherein one of:
an area ratio, of a first area of the first user portion to a second area of the second user portion, is the same as the total ratio of the first total to the second total; or
a first area proportion of the first area relative to a total area is the same as the proportion of the first total relative to the joint total, wherein the total area is a sum of the first area and the second area.

16. The user device of claim 14, wherein a radius ratio, of a first radius of the first user portion to a second radius of the second user portion, is the same as the total ratio of the first total to the second total or as the proportion of the first total or the second total relative to the joint total.

17. The user device of claim 13, wherein the connecting portion has two opposing sides that have a concave profile.

18. The user device of claim 13, wherein the one or more processors are further configured to:
detect a second user interaction, with the user device, that indicates a selected one of the first user portion or the second user portion; and
present, on the user interface and based on the second user interaction, account information associated with one of the first user account or the second user account corresponding to the selected one of the first user portion or the second user portion.

19. The user device of claim 13, wherein the one or more processors are further configured to:
present, on the user interface and on the user interface element, a joint total that is a sum of the first total and the second total; and
present, on the user interface and external to the user interface element, the first total and the second total.

20. The user device of claim 13, wherein the user interface element includes a first user identifier, associated with the first user account and in connection with the first user portion, and a second user identifier associated with the second user account and in connection with the second user portion.
